(19) United States
(12) Patent Application Publication
(10) Pub. No.: US 2024/0298362 A1
(43) Pub. Date: Sep. 5, 2024

(54) ASSISTANCE IN TRANSITION OF WIRELESS TERMINAL TO CONNECTED STATE

(71) Applicant: Sony Group Corporation, Tokyo (JP)

(72) Inventor: Rickard LJUNG, Helsingborg (SE)

(21) Appl. No.: 18/036,380

(22) PCT Filed: Nov. 15, 2021
(86) PCT No.: PCT/EP2021/081715

§ 371 Date: May 10, 2023

(30) Foreign Application Priority Data
Dec. 1, 2020 (SE) 2051400-6

(51) Int. Cl. H04W 76/10; H04W 24/10; H04W 72/044; H04W 76/20

(52) U.S. Cl. CPC H04W 76/10; H04W 24/10; H04W 72/044; H04W 76/20

(57) ABSTRACT

A method performed in a user equipment, UE, for assisting transition of the UE from an unconnected state to a connected state with respect to an access network, the method comprising: obtaining (S420) a trigger to make a transition to the connected state; communicating (S430) signals with the access network, in response to said trigger, to obtain channel measurement according to a first configuration of channel resources usable for communicating with the access network in the connected state; transmitting (S440) a message, using a second configuration of channel resources, to request connection to the access network; wherein the first configuration comprises one or more configuration settings which are different from the second configuration, whereby the channel measurement assists the access network in applying a communication configuration according to the first configuration upon entering the connected state.

### FIELD OF THE INVENTION

The technology of the present disclosure relates generally to operations of a wireless terminal and of an access network, in the process of transition from an unconnected state to a connected state. Specifically, solutions are provided for terminal-assisted evaluation support in such a transition process, such as a random access procedure.

### BACKGROUND

In existing wireless communications systems, wireless terminals are configured to wirelessly communicate data and information with an access network of a wireless network. Various protocols and specifications for operating and controlling such communication are e.g. provided in technical specification documents launched within the Third Generation Partnership Project (3GPP), including e.g. 4G-based systems, also referred to as Long Term Evolution (LTE) and 5G. A term commonly used for denoting a wireless terminal for communication in such a system is User Equipment (UE), which will be used throughout this disclosure. The access network may comprise a plurality of base stations, herein referred to as access nodes, configured for wireless communication with UEs. The access network is in turn connected to a backbone referred to as a core network, which inter alia connects the wireless network to other systems and networks.

In 3GPP systems, as well as in other types of wireless communication systems, UE may selectively be held in a connected state or in an unconnected state, with regard to the access network. In a connected state an active communication channel is configured between the UE and the access network. In an unconnected state, there is no active communication channel between the UE and the access network, although signals may be shared for information exchange, such as for transitioning to a connected state. In current 3GPP terms, the connected state may be referred to as RRC (Radio Resource Control) Connected. One unconnected state may be referred to as RRC Idle. In the radio access technology referred to as New Radio (NR), which may be used in 5G wireless systems, a further state is specified as RRC Inactive. In this state, the UE is suspended from active connection to the access network, while an active connection is maintained between the access network and the core network. The connected state RRC Connected may be reactivated responsive to a resume process. A similar procedure of suspending and resuming connection is provided for in LTE.

For each new generation of wireless communication systems, the systems become more and more flexible in its resource allocation and spectrum usage. In 5G systems a large amount of frequency bands can be utilized, both on licensed and unlicensed spectrum. Further there are both uplink and downlink carrier aggregation opportunities, and within each utilized NR carrier there can be multiple so-called bandwidth parts (BWPs) configured and dynamically utilized. For data scheduling, the access network can activate and utilize multiple Radio Access Technologies (RATs) simultaneously, such as LTE and NR, and with large flexibility schedule the data traffic using the configured access technologies. Further, from an ultra-reliable, low-latency communication (URLLC) perspective, there are several mechanisms introduced to perform communication with short latency and high reliability, such as performing multiple transmissions, introducing short time slots etc. In general, in order to perform communication according to various requirements, such as with low latency, high data rates, and high system capacity, there is a desire to quickly setup and communicate using the most suitable radio resources available. With such targets, there are opportunities to further improve the transition phase between an unconnected state and a connected state in order to prepare the network to select such most suitable radio resources as quickly as possible.

### SUMMARY

The proposed solutions provided in the present disclosure relate to processes carried out in association with a transition from an unconnected state to a connected state of a UE with regard to an access network. The proposed solution is defined by the terms of the independent claims. Various further aspects of the proposed solution are set out in the dependent claims.

According to one aspect, a method performed in a UE is provided for assisting transition of the UE from an unconnected state to a connected state with respect to an access network, the method comprising:
obtaining a trigger to make a transition to the connected state;
communicating signals with the access network, in response to said trigger, to obtain channel measurement according to a first configuration of channel resources usable for communicating with the access network in the connected state;
transmitting a message, using a second configuration of channel resources, to request connection to the access network;
wherein the first configuration comprises one or more configuration settings which are different from the second configuration, whereby the channel measurement assists the access network in applying a communication configuration according to the first configuration upon entering the connected state.

According to another aspect, a method performed in an access node of an access network is provided, for facilitating transition of a UE from an unconnected state to a connected state with respect to the access network, the method comprising:
obtaining a trigger to make a transition to the connected state;
communicating signals with the UE, in response to said trigger, to obtain channel measurement according to a first configuration of channel resources usable for communicating with the UE in the connected state;
receiving a message, using a second configuration of channel resources, from the UE to request connection to the access network;
wherein the first configuration comprises one or more configuration settings which are different from the second configuration;
applying, based on the channel measurement, a communication configuration according to the first configuration upon entering the connected state.

By means of the proposed solution, a UE-assisted radio channel evaluation support mechanism is obtained for use in the transition to the connected state, such as in a random access procedure, whereby configuration of the connection may be suitably obtained in the access network based on the current context. The proposed solution thus provides for transition mode measurements, wherein measurements are carried out responsive to a trigger to make a transition of the UE to a connected state.

### BRIEF DESCRIPTION OF THE DRAWINGS

Various examples and use cases of the proposed solution will be described below with reference to the accompanying drawings, in which

FIG. 1 illustrates a wireless network including an access network, in which network the proposed solutions may be carried out;

FIG. 2 schematically illustrates functional elements of a UE configured to carry out various aspects of the proposed solution;

FIG. 3 schematically illustrates functional elements of an access node configured to carry out various aspects of the proposed solution;

FIG. 4 is a flowchart of a method carried out in a UE according to various embodiments;

FIG. 5 is a flowchart of a method carried out in an access node according to various embodiments;

FIG. 6 shows a signaling diagram of various process steps carried out according to the proposed solution;

FIG. 7A shows a diagram of embodiments carried out in a 4 step access procedure; and

FIG. 7B shows a diagram of embodiments carried out in a 4 step access procedure.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

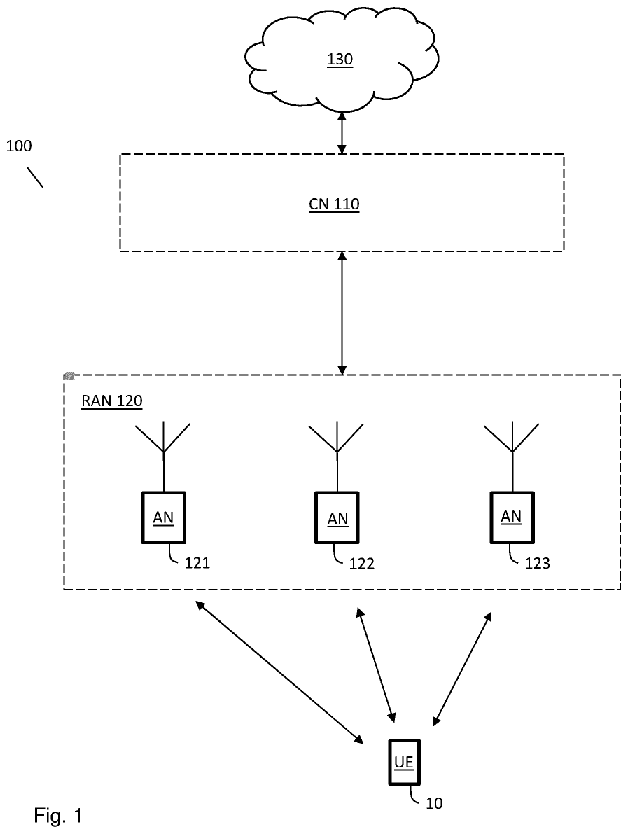

FIG. 1 schematically illustrates a wireless communication system, providing an example of a scene in which the solutions provided herein may be incorporated. The wireless communication system includes a wireless network 100, and a UE 10 configured to wirelessly communicate with the wireless network 100. The wireless network 100 comprises a core network 110, which may be connected to other communication networks 130. The wireless network 100 further comprises at least one access network 120, usable for communication with UEs of the system. Such access networks may comprise a plurality of access nodes (AN) or base stations 121-123, configured to provide a wireless interface for, inter alia, the UE 10. The access nodes 121-122 may be stationary or mobile. Each access node comprises a point of transmission and reception, referred to as a Transmission and Reception Point (TRP), which coincides with an antenna of the respective access node. Logic for operating the access node may be configured at the TRP or at another physical location.

The UE 10 may be any device operable to wirelessly communicate with the network 100 through the access network 120, such as a mobile telephone, computer, tablet, a M2M device or other.

The solutions proposed herein include methods for assisting transition of the UE 10 from an unconnected state to a connected state with respect to the access network 120. Before discussing various aspects of those solutions, functional elements for at least some of the nodes involved will be briefly discussed.

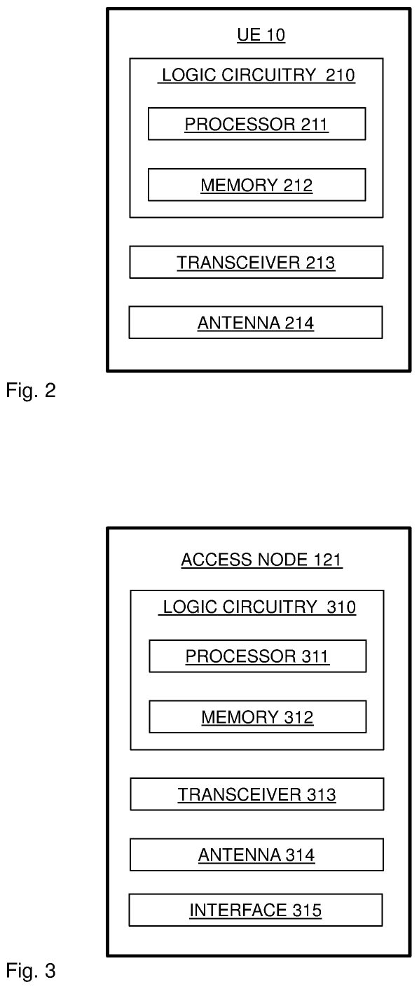

FIG. 2 schematically illustrates an example of the UE 10 for use in a wireless network 100 as presented herein, and for carrying out various method steps as outlined.

The UE 10 comprises a wireless transceiver 213, such as a radio module, for communicating with other entities of the radio communication network 100, such as the access nodes 121-123, in accordance with different configuration settings. The transceiver 213 may thus include a radio receiver and transmitter for communicating through at least an air interface.

The UE 10 may further comprise an antenna system 214, which may include one or more antenna arrays. In various examples the UE 10 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception.

The UE 10 further comprises logic circuitry 210 configured to communicate data, via the transceiver, on a radio channel, to the wireless communication network 100 and possibly directly with another terminal by Device-to Device (D2D) communication.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

Obviously, the UE 10 may include other features and elements than those shown in the drawing or described herein, such as a power supply, a casing, a user interface, sensors, etc., but are left out for the sake of simplicity.

FIG. 3 schematically illustrates an example of an access node 121 for use in a wireless network 100 as presented herein, and for carrying out various method steps as outlined. The function and configuration of the access node 121 may apply also the other access nodes 122-123 mentioned herein. As indicated above, the access node 121 is may alternatively referred to as the TRP 121. In the context of the present disclosure, an antenna system of the access node at least partly defines the TRP, whereas others of the functional elements of the access node described below may be situated remotely.

The access node 121 comprises a wireless transceiver 313 for communicating with UEs of the radio communication network 100, such as the UE 10, according to different configuration settings. The transceiver 313 may thus include a radio receiver and transmitter for communicating through at least an air interface.

The access node 121 may further comprise, or be connected to, an antenna system 314, which may include one or more antenna arrays. The antenna system 314 may comprise a plurality of antennas for operation of different beams in transmission and/or reception.

The access node 121 further comprises an interface 315 for communicating with various entities of the wireless network 100, such as the core network 110 and other access nodes 122-123.

The core network further comprises logic circuitry 310 configured to communicate data on a radio channel via the radio transceiver 313 to UEs, and further configured to communicate data with the core network 110.

The logic circuitry 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic circuitry 310 is configured to control the core network to carry out any of the method steps as provided herein. Software defined by said computer program code may include an application or a program that provides a function and/or a process. The software may include device firmware, an operating system (OS), or a variety of applications that may execute in the logic circuitry 310.

The proposed solution provides a support mechanism for use in the transition from an unconnected state to a connected state of the UE 10 with respect to the access network 120. This may take place in association with a so-called RACH (Random Access Channel) process to connect to the network 100, which as such will not be outlined in detail herein.

In legacy 3GPP standard documentation two types of measurement reporting from UEs have been considered. One is so-called quality reporting in message 3 (msg3), which is an RRC Connection Request message sent in uplink (UL) from the UE to the access network in the RACH process. Quality reporting was introduced in 3GPP Release 16 and provides a possibility for the network to retrieve a Channel Quality Indicator (CQI) report from the UE as part of the RACH procedure. The feature was introduced as part of the IoT standards, a.k.a Machine Type Communications and Narrowband IoT.

The solution proposed herein provides additions and further functionality that may be applied on top of existing quality reporting, as one implementation possibility. However, the proposal in this document is rather tailored for other than low data rate IoT solutions.

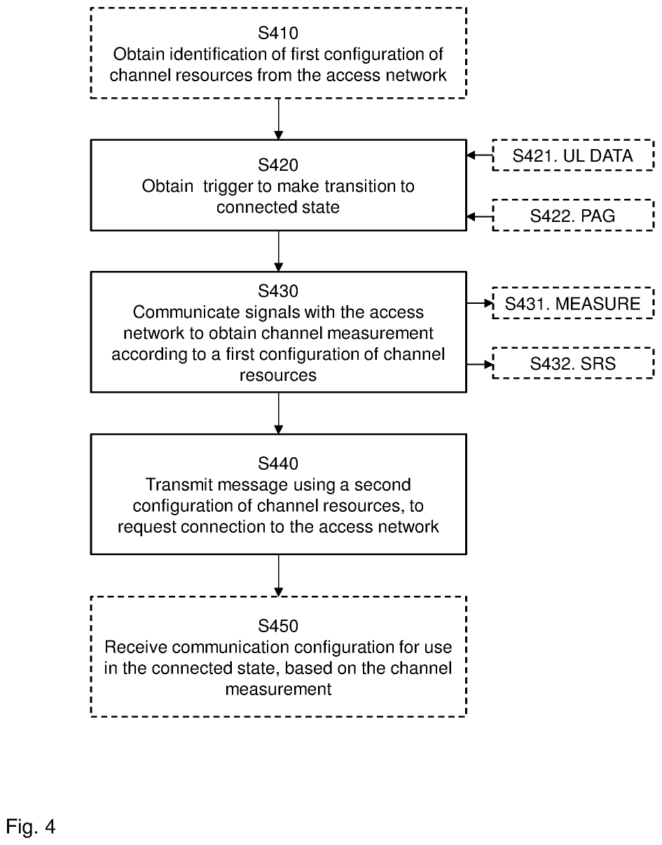

FIG. 4 is a flow chart disclosing various steps of a process performed in the UE 10 for assisting transition of the UE 10 from an unconnected state to a connected state with respect to the access network 120. The UE 10 may comprise the logic circuitry 210 configured to control the UE 10. The logic circuitry 210 may comprise logic in the form of computer code and instructions, stored in the memory storage 212, which is executed in the processor 211 to control the UE 10 to carry out any of the steps outlined herein as carried out in or by the UE 10.

The UE 10 may thus be controlled to obtain S420 a trigger to make a transition to the connected state. As will be described, the trigger may e.g. comprise determination S421 of UL data to transmit from the UE 10, or reception S422 of a paging signal from the access network 120.

The UE 10 may further be controlled to communicate S430 signals with the access network, in response to said trigger, so as to obtain channel measurement according to a first configuration of channel resources usable for communicating with the access network in the connected state. As will be described, communicating signals may e.g. comprise measuring S431 signal characteristics received in the UE 10 according to the first configuration of channel resources, and/or transmitting S432 uplink signals, e.g. SRS, according to the first configuration of channel resources for measurement of signal characteristics in the access network 120.

In various embodiments, the UE is controlled to obtain S410 an identification of the first configuration of channel resources from the access network 120 in conjunction with entering the unconnected state. This may thus take place while the UE 10 is in connected state, prior to entering the unconnected state. Entering the unconnected state may be carried out by the access network 120 releasing or suspending connection with the UE 10, or the UE 10 terminating the connection.

The UE 10 may further be controlled to transmit S440 a message, using a second configuration of channel resources, to request connection to the access network 120. Here, the first configuration comprises one or more configuration settings which are different from the second configuration, whereby the channel measurement assists the access network in applying a communication configuration according to the first configuration for use in the connected state.

The UE 10 may further be controlled to receive (S450) a communication configuration from the access network for use in the connected state, wherein the communication configuration is obtained in the access network based on the channel measurement. In one or more examples the UE 10 may, upon receiving the communication configuration, be in the transition to the connected state and can apply the configuration upon being transitioned to the connected state. In one or more examples the UE 10 may upon receiving the communication configuration already have fully transitioned to the connected state, and the UE can apply the adapted configuration upon receiving it from the access network. Examples related to parameters of the communication configuration are provided below.

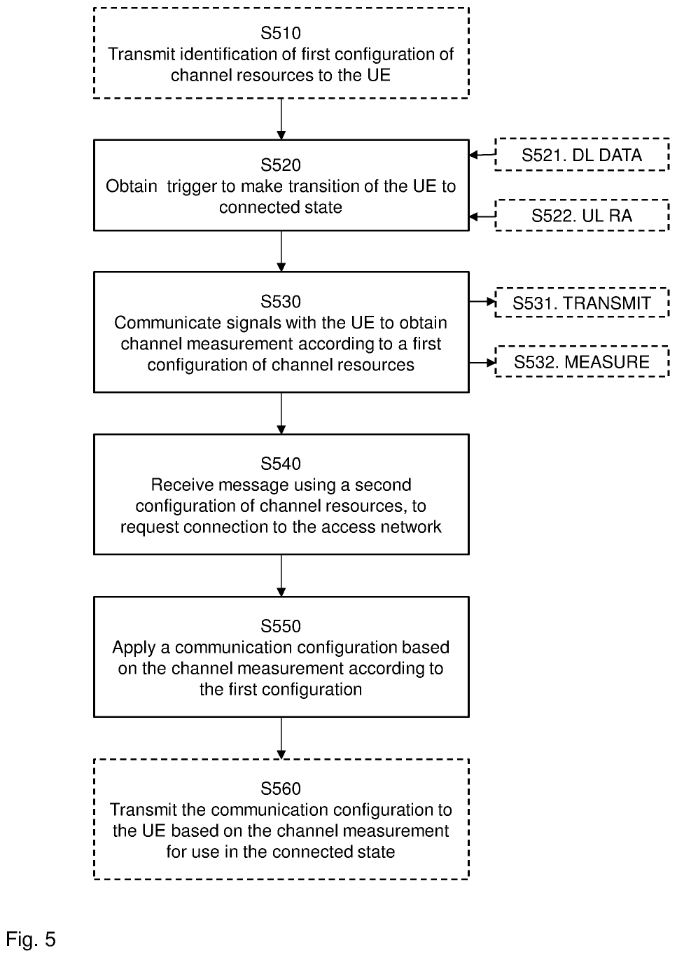

FIG. 5 is a flow chart disclosing various steps of a process performed in the access network 120, such as in the access node 121, for transition of the UE 10 from an unconnected state to a connected state with respect to the access network 120. The access node 121 may comprise the logic circuitry 310 configured to control the access node 121. The logic circuitry 310 may comprise logic in the form of computer code and instructions, stored in the memory storage 312, which is executed in the processor 311 to control the access node 121 to carry out any of the steps outlined herein as carried out in or by the access node 121.

The access node 121 may thus be controlled to obtain S520 a trigger to make a transition to the connected state. The trigger may e.g. comprise determination S521 of DL data to transmit from to the UE 10 or the associated transmission of a paging message to the UE 10, or reception S522 of a message or signal, such as a random access (RA) message from the UE 10.

The access node 121 may further be controlled to communicate signals with the UE 10, in response to said trigger, to obtain channel measurement according to a first configuration of channel resources usable for communicating with the UE 10 in the connected state.

Communicating signals may e.g. comprise transmitting S531 signals and/or data using the first configuration, such as by broadcast or in communication with other UEs. In this context, the transmission of signals and/or data need not be caused by the trigger as such. Rather, upon occurrence of the trigger, the UE 10 may be controlled to make measurement of any transmission S531 carried out by the access node 121 according to the first configuration. Alternatively, or additionally, the access node 121 is controlled, responsive to the occurrence of the trigger, to measure S532 uplink signals, e.g. SRS. transmitted by the UE 10 according to the first configuration of channel resources.

In various embodiments, the access node 121 is controlled to transmit S510 an identification of the first configuration of channel resources to the UE 10 in conjunction with the UE 10 entering the unconnected state. This may thus take place while the UE 10 is in connected state, prior to entering the unconnected state. Entering the unconnected state may be carried out by the access network 120 releasing or suspending connection with the UE 10, or the UE 10 terminating the connection.

The access node 121 may further be controlled to receive S540 a message, using a second configuration of channel resources, from the UE 10 to request connection to the access network 120. Here, the first configuration comprises one or more configuration settings which are different from the second configuration, whereby the channel measurement assists the access network in applying a communication configuration according to the first configuration upon entering the connected state.

The access node 121 may further be controlled to apply S550, based on the channel measurement, a communication configuration according to the first configuration for use in the connected state. This may involve determining one or more configuration settings based on the channel measurement.

The access node 121 may further be controlled to transmit S560, to the UE, information identifying the applied communication configuration for use in the connected state. Thereby, the UE 10 may be fully transitioned to the connected state.

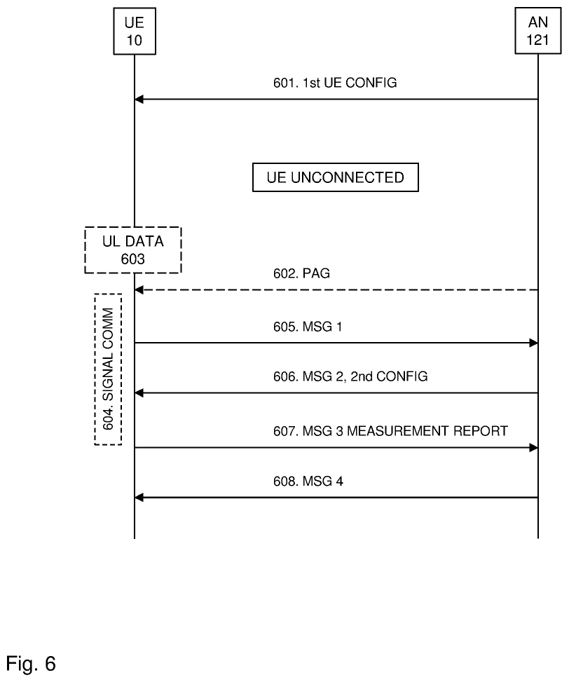

FIG. 6 shows a signaling diagram of various steps carried out in different embodiments of the proposed solution, and different aspects of the solution and details of various embodiments will now be described in reference thereto. The process will predominantly be described in the order presented in the drawing, from top to bottom. Certain process steps may however be carried out in a different order in certain embodiments.

On a general level, it is proposed to introduce a functionality to allow an access network 120 to configure the UE 10 to be prepared to communicate signals with the access network 120, such as to conduct measurements and report them, and/or transmit sounding signals, as part of the initial access procedure or other procedure conducted when the UE 10 enters a connected operation state from a dormant, unconnected, state. One specific initial access procedure is for example a random-access signaling transmission, when the UE 10 enters RRC connected from RRC idle. Other procedures relevant for the proposed mechanism includes but is not limited to when the UE 10 enters fully connected state after being in suspend mode (LTE) or inactive (NR) mode.

With reference to FIG. 6, the proposed method may rely on an initial step of configuration of the step of communicating signals S430, S530, i.e. what the UE 10 is required to measure and/or transmit. This may be classified as a re-establishment assistance configuration signaling. In the drawing, this configuration signaling is exemplified by the step of the UE 10 obtaining an configuration settings of a first configuration 601 of channel resources from the access network 120, in conjunction with entering the unconnected state, such as RRC Idle or Inactive in an NR deployment. The obtainment may thus include receiving the configuration settings of the first configuration 601 in the UE 10 by dedicated UE signaling, e.g. as part of an RRC connection release, or a RRC inactive/suspend initiation. In this case, the access network 120 may, as part of such procedure when UE enters a dormant state, signal an assistance configuration or a signal indicative of a specific pre-determined configuration. In other embodiments, the UE 10 may obtain broadcast information, such as system information, from the access network 120, identifying the configuration settings of the first configuration 601. The configuration settings of the first configuration 601 of channel resources may identify at least one of a radio access technology, a frequency band, a bandwidth part, and a beam configuration.

It may be noted here that although the drawing indicates a single access node 121, the configuration settings of the first configuration 601 may be obtained from any access node of the access network 120, and not necessarily the same access node to which connection is later established.

In some embodiments, the step of communicating S430 signals with the access network 120 includes measuring signal characteristics in the UE 10. In various embodiments, the configuration settings of the first channel resources 601 may identify a measurement configuration for the UE 10 use, to detect and measure such signal characteristics. The configuration settings may identify any of e.g.
one or more radio access technologies (RAT);
one or more BWPs, such as configured BWPs or activated BWPs;
one or more resource elements such as time and frequency portions within a frequency band;
one or more time periods;
one or more frequency bands;
one or more beam configurations;
one or more antenna configurations;
one or more signal types, e.g. indicative of a signaling sequence;
one or more types of measurement to conduct and report. The type of measurement may comprise one or more of:
   Received signal strength indication (RSSI);
   Received signal power (RSRP)
   Channel occupancy, such as an indication of a ratio indicating the amount of a frequency band being sensed as utilized (sensed energy over a threshold level)
   Signal-to-noise and Interference ratio (SNIR).

In some embodiments, the step of communicating S430 signals with the access network 120 includes transmitting UL signals from the UE 10, according to the first configuration 601 of channel resources, for measurement of signal characteristics in the access network 120. The UL signals may be pilot signals, such as SRS. In various embodiments, the configuration settings may identify one or more of
type of signal to transmit, e.g. indicative of any or a combination of a pilot sequence definition, pilot sequence length, details of a signal design e.g. indication of modulation, coding, output power or similar;
time indication for the transmission of UL signal.

The configuration settings of the first configuration 601 of channel resources may thus provide information to the UE 10, such that it may communicate signals with the access network 120 to obtain channel measurement. In some embodiments, this may involve tuning the transceiver 213 of the UE 10 to sense and measure signal characteristic to obtain measurement data according to the configuration settings of the first configuration of channel resources 601, related to the radio environment the UE 10 is present in. In some embodiments, this may involve tuning the transceiver 213 of the UE 10 to transmit UL signals for receipt in the access network 120 to obtain measurement data according to the configuration settings of the first configuration of channel resources 601. This may subsequently be used by the access network, upon making a transition from an unconnected state to a connected state of the UE 10, to conveniently apply a suitable communication configuration based on the channel measurement.

Upon, or at some point after, obtaining the configuration settings of the first configuration 601 of channel resources, the UE 10 is arranged in an unconnected state with respect to the access network 120, such as RRC Idle or Inactive.

When the UE 10 is held in the unconnected state, the UE 10 may at some point obtain S420 a trigger to make a transition to the connected state. In some scenarios, the trigger may involve receiving a paging message 602 from the access network 120. In other scenarios, obtaining the trigger may involve determining an uplink data event 603 in the UE 10, such as the presence of data in a transmit buffer of the UE 10.

Responsive to the trigger, the UE 10 and/or the access node 121 are controlled to communicate signals 604 to obtain channel measurement according to the first configuration 601 of channel resources. As noted, this may involve controlling the UE 10 to measure signal characteristics and/or transmitting UL signals, according to the first configuration 601. The communication of signals 604 may in some embodiments be carried out immediately after obtaining the trigger. In other embodiments, the UE 10 and/or the access node 121 may be controlled to communicate signals 604 at a configured time, e.g. with respect to a reference point in time, such as a certain scheduled time of reception or transmission of a signal of the random access procedure.

The obtained trigger will in some embodiments cause an access procedure for transition to the connected state. This may include receiving, from the access node 121, a message indicative of second configuration of channel resources. FIG. 6 illustrates an example of a 4 step random access procedure, in which the UE 10 is controlled to transmit a preamble 605 as message 1 for receipt in the access network 120. The access node 121 may respond with a Random Access Response (RAR) message 2 to obtain UL link synchronization between UE 10 and the access node 121, comprising a second configuration 606 of resources for use in RRC. The UE 10 may subsequently transmit S440 a RRC Connection Request 607 in a message 3, using the second configuration 606 of channel resources, to request connection to the access network 120. The second configuration of channel resources may correspond to a set of resources utilized for the signaling the transition to a connected state, such as the uplink and/or downlink channel resources utilized for transmission of the preamble and/or the random access response message. In various examples, such second configuration of channel resources may correspond to an initial or default bandwidth part, a frequency band used to communicate the transition to connected state, or an antenna configuration used for the signaling the transition to connected state. It can be noted that communication to provide signaling in the transition to a connected state may require a limited amount of communication resources in relation to the resources that may be required for data communication during a connected state. Therefore a larger amount of communication capabilities and resources may be required to be configured for use in the connected state compared to the needs for communicating the transition. The first configuration of channel resources may therefore correspond to different and/or additional bandwidth parts, frequency bands, radio access technologies, antenna configurations and other parameters that would allow for different resource allocation compared to the second configuration.

The first configuration 601 thus comprises one or more configuration settings which are different from the second configuration 606. This way, the channel measurement obtained by the communication of signals 604 assists the access network 120 in applying a communication configuration according to the first configuration 601 upon entering the connected state.

In various embodiments, the applied communication configuration identifies a specific configuration setting for use in the connected state, such as parameter values or selections identifying one or more of RAT, BWP, resource elements, time periods, frequency bands, beam configurations, antenna configurations, or other configuration parameters forming part of the first configuration.

It may be noted that in certain scenarios, measurement carried out based on the communication of signals using configuration settings of the first configuration may still result in the communication configuration being applied in accordance with various configuration settings of the presently used, second, configuration of channel resources, such as e.g. the same RAT, BWP, beam configuration, or other. In particular, this may be the result if the second configuration of channel resources identifies a subset of the first configuration of channel resources, and the obtained measurement provides that the second configuration of channel resources is suitable or most suitable for use in the connected state.

The assistance obtained by UL transmission and/or measurement(s) and the reporting of received signals, during the transition from dormant to active state, provides the effect of quickly preparing the access network 120 with the current status of channel conditions on possible, but currently not utilized, communication resources at the time of transition to an active connection for the UE 10 with the access network 120. Hence, the reporting and/or UL transmission is proposed to be part of the signaling that achieves the transition from the dormant state to the active state, such as the random access procedure. As opposed to legacy behavior, the UE is pre-configured to carry out the assistance signaling in an early stage of the transition, prior to actually being in the fully connected state.

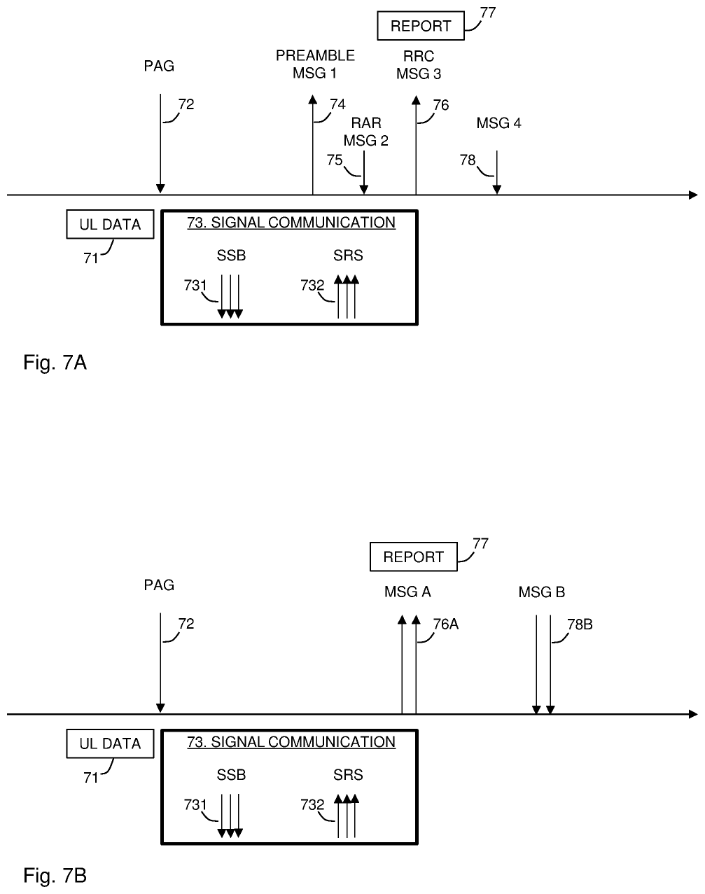

As a complement to FIG. 6, FIGS. 7A and 7B provide schematic representations of the proposed solution from the aspect of the UE 10.

FIG. 7A illustrates an embodiment of the proposed method as implemented in a four-step random access procedure, wherein transition may be made from RRC Idle to RRC Connected.

A trigger to enter connected state may be provided by determination of present data 71 in the UE 10 for UL transmission, or reception of a paging message 72.

The communication of signals 73, executed based on the trigger, may e.g. involve measuring signal characteristics of received signals, e.g. Synchronization Signal Blocks (SSBs) 731, and/or transmission of UL signals, e.g. SRS for measurement in the access network 120. The communication of signals is carried out using the first configuration of resources, as obtained in a previous step S410 as described.

The RA process may comprise transmitting a preamble 74 as message 1 and receiving a random access response 75 as message 2. Where the communication of signals includes measuring received signal characteristics 731, a measurement report 77 may be transmitted in the RRC message 3.

Upon reception of a message 4 to obtain contention resolution, the UE 10 may receive information identifying an applied communication configuration for use in the connected state, based on the measurement report 77, to complete the transition to the connected state.

FIG. 7B schematically illustrates an embodiment of the proposed method as implemented in a two-step random access procedure, wherein transition may be made from RRC Idle to RRC Connected.

A trigger to enter connected state may be provided by determination of present data 71 in the UE 10 for UL transmission, or reception of a paging message 72.

The communication of signals 73, executed based on the trigger, may e.g. involve measuring signal characteristics of received signals, e.g. Synchronization Signal Blocks (SSBs) 731, and/or transmission of UL signals, e.g. SRS for measurement in the access network 120. The communication of signals is carried out using the first configuration of resources, as obtained in a previous step S410 as described.

The RA process may comprise transmitting an UL message 76A as a message A. Where the communication of signals includes measuring received signal characteristics 731, a measurement report 77 may be transmitted in or as part of the UL message 76A.

Upon reception of a subsequent message, the UE 10 may receive information identifying an applied communication configuration for use in the connected state, based on the measurement report 77, to complete the transition to the connected state.

For embodiments of the proposed solution where the communication of signals includes measurement of received signals 731 according to the first configuration of resource, the measurement may naturally be conducted prior to the reporting occasion. In some embodiments, time constraints may be provided associated with the time between UE 10 performing the configured measurement 604, 73 and the time of reporting 607, 77. The time constraint may in various embodiments be predetermined and provided by technical specification. In other embodiments, the time constraints may be specified by the access network 120. In some embodiments, an acquired identification of the first configuration of channel resources, as obtained from the access network 120, may in various embodiments identify a time indication associated with communicating said signals, such as by identifying a specified time constraint or directly specifying the time constraint. The UE 10 may thereby be configured to transmit the measurement report message with a time offset, based on said time indication, after measuring signal characteristics.

For embodiments of the proposed solution where the communication of signals includes UL transmission of signals 732, the configuration of settings may identify e.g. sounding of pilot signals (reference signals) according to the first configuration of resource, such as on specific resources, e.g. one or more bandwidth parts or similar. The UE 10 may be controlled to transmit these signals 732 at the same time as, or with a certain offset in relation to one or more messages of the RACH process. This may in some embodiments be determined by a time indication of the acquired identification of the first configuration of channel resources, as obtained from the access network 120. As one example—the UE 10 may be configured to transmit UL signals a given amount of time units, e.g. ms, slots or frames or similar, after a trigger, such as a received resume request message or paging message.

In some embodiments, the usage of the proposed assistance feature to communicate signals 604 according to any of the embodiments outlined herein, in the process of a transition from an unconnected state to a connected state, may be activated/inactivated on cell level, e.g. as part of a system information signaling from the access node 121 operating the associated cell. In some embodiments, such system information may be indicative of whether the UE 10 shall perform the assistance during one type or for all types of transitions to active state procedures. In some embodiments, the activation may be obtained on UE level, e.g. that the UE 10 shall only carry out the assistance according to the proposed method in case such activation was indicated when the UE entered the preceding unconnected, dormant, state, or if such indication was provided as part of a paging message 602, 72 to the UE 10.

Various embodiments have been described in the foregoing, associated with the proposed solution. Unless clearly contradictory, these embodiments may be combined in any form, or as in the foregoing.

1. A method performed in a user equipment (UE) for assisting transition of the UE from an unconnected state to a connected state with respect to an access network, the method comprising:
obtaining a trigger to make a transition to the connected state;
communicating signals with the access network, in response to said trigger, to obtain channel measurement according to a first configuration of channel resources usable for communicating with the access network in the connected state;
transmitting a message, using a second configuration of channel resources, to request connection to the access network;
wherein the first configuration comprises one or more configuration settings which are different from the second configuration, whereby the channel measurement assists the access network in applying a communication configuration according to the first configuration upon entering the connected state.

2. The method of claim 1, wherein the second configuration of channel resources identifies a subset of the first configuration of channel resources.

3. The method of claim 1, wherein the configuration settings of the first configuration of channel resources identifies at least one of a radio access technology, a frequency band, a bandwidth part, and a beam configuration.

4. The method of claim 1, comprising: receiving, from the access network, a communication configuration for use in the connected state, wherein the communication configuration is obtained in the access network based on the channel measurement.

5. The method of claim 4, wherein the communication configuration identifies selected configuration settings of the first configuration of channel resources.

6. The method of claim 1, wherein obtaining a trigger comprises: receiving a paging message from the access network.

7. The method of claim 1, wherein obtaining a trigger comprises: determining an uplink data event in the UE.

8. The method of claim 1, comprising: receiving, from the access node, a message indicative of the second configuration of channel resources.

9. The method of claim 1, wherein communicating signals comprises: measuring signal characteristics received according to the first configuration of channel resources, wherein said transmitted message comprises a measurement report of the measured signal characteristics.

10. The method of claim 1, wherein communicating signals comprises: transmitting uplink signals according to the first configuration of channel resources for measurement of signal characteristics in the access network.

11. The method of claim 10, wherein the first configuration of channel resources identifies at least one of a pilot sequence definition, a pilot sequence length, signal modulation, signal coding, and output power, for transmission of the uplink signals.

12. The method of claim 1, comprising: obtaining an identification of the first configuration of channel resources from the access network in conjunction with entering the unconnected state.

13. The method of claim 12, wherein said identification of the first configuration of channel resources identifies a time indication associated with communicating said signals.

14. The method of claim 9, wherein said identification of the first configuration of channel resources identifies a time indication associated with communicating said signals, and wherein said message is transmitted with a time offset, based on said time indication, after measuring signal characteristics.

15. The method of claim 1, wherein said states are Radio Resource Control (RRC) states, and wherein the UE is RRC Connected in the connected state.

16. The method of claim 15, wherein the UE is RRC Idle in the unconnected state.

17. The method of claim 15, wherein the UE is RRC Inactive in the unconnected state.

18. A method performed in an access node of an access network for transition of a user equipment (UE) from an unconnected state to a connected state with respect to the access network, the method comprising:
obtaining a trigger to make a transition to the connected state;
communicating signals with the UE, in response to said trigger, to obtain channel measurement according to a first configuration of channel resources usable for communicating with the UE in the connected state;
receiving a message, using a second configuration of channel resources, from the UE to request connection to the access network;
wherein the first configuration comprises one or more configuration settings which are different from the second configuration;
applying, based on the channel measurement, a communication configuration according to the first configuration upon entering the connected state.

19. The method of claim 18, wherein the second configuration of channel resources identifies a subset of the first configuration of channel resources.

20. The method of claim 18, wherein the configuration settings of the first configuration of channel resources identifies at least one of a radio access technology, a frequency band, a bandwidth part, and a beam configuration.

21-34. (canceled)
